(19) United States
(12) Patent Application Publication
(10) Pub. No.: US 2019/0102473 A1
(43) Pub. Date: Apr. 4, 2019

(54) RENDERER FOR VISUAL REPRESENTATIONS

(71) Applicant: General Electric Company, Schenectady, NY (US)

(72) Inventors: Benoit CHEVALIER, Walnut Creek, CA (US); Jaime NAHMAN, Berkeley, CA (US)

(21) Appl. No.: 15/721,013

(22) Filed: Sep. 29, 2017

(51) Int. Cl. G06F 17/30; H04L 29/08

(52) U.S. Cl. CPC G06F 17/30905; H04L 67/02; G06F 17/30554; G06F 17/30896

(57) ABSTRACT

The example embodiments are directed to a system and method for rendering visual representations. In one example, the method includes receiving a processing request to render a visual representation on a browser, identifying a current target of a plurality of targets for rendering, rendering the current target using a browser processing component, and based on an ordered rendering, obtaining rendering information about the rendering of the current target, the rendering information including an amount of points being output and a time interval for rendering the amount of points, determining an amount of future rendering points to output for the visual representation during a future time interval based on the rendering information obtained for the current target.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as trains and aircraft, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Raw data captured and analyzed from an asset is not very user-friendly and often includes multiple components and variables. In order to visualize data in a more convenient manner, visual representations are often provided based on data variables and can include various types of charts, diagrams, graphs, and the like. When displayed via a browser, a visual representation can consume a significant amount of web resources thus diminishing the processing speed of a system processing a display of the visual representation. Furthermore, when multiple visual representations are displayed via the same web page, at the same time, the processing speed of the system is even further reduced. A need for intensive computing may lead to an unpleasing user experience with some processors and/or browsers.

Content display devices have become increasingly sophisticated. Accordingly, users have come to expect that the web pages they visit will be interactive, react quickly, and render smoothly. When large amounts of data are requested to be rendered on a user interface (UI), current systems often fail to process the tasks required to render the screen in a manner that provides a smooth viewing experience.

Some of the challenges of rendering smoothly in a browser include situations where different browsers render at different speeds and hardware capabilities vary from machine to machine. Moreover, programmers typically have the ability to control only a portion of a rendering cycle (e.g., a JavaScript execution portion using JavaScript code to handle work that will result in visual changes).

What is needed is system and method capable of achieving a jank-free user interface, displaying visual representations of data (e.g., more specifically, of large data sets) via a web browser in a smooth and uninterrupted manner.

### SUMMARY

Embodiments described herein improve upon the prior art by providing systems and methods which enable visual representations of data (e.g., more specifically, of large data sets) to be displayed via web browser without the undesirable effects described above. User experience may be optimized.

As described herein, a visual representation may include a chart, a line, a graph, or the like, having a plurality of data points that are related to one another using variables. The visual representation may correspond to web content displayed via web page. Typically, the more visual representations displayed on a web page, the slower the processing speed of the page. In some embodiments, visual representations are generated based on data which may be time-series data acquired from or associated with one or several assets such as a machine or equipment used in industry or manufacturing.

The disclosed embodiments relate to a renderer for visual representations. In the context of chart visualizations (e.g., lines and/or markers within a chart), the disclosed embodiments render the chart visualizations progressively, with each chart having its own rendering component that handles ordering of the rendering. The renderer significantly increases the speed for rendering visual representations by ensuring that the rendering process uses the maximum hardware capabilities available as well as renders smoothly any amount of data on any browser, irrelevant of what other computation is currently happening on a computing device.

The renderer can automatically adjust the number of points rendered for a given amount of time (e.g., per second) by measuring how many points it was able to draw on each frame on average over the last certain number of frames to decide how many points it should draw on the next frame. Some of the benefits of the visual chart renderer include smooth drawing, immediate feedback for the user (e.g., user sees the chart and the drawing starts almost instantaneously) and maximum use of hardware capabilities for fast rendering.

As a result, the visual processing of the representations displayed via the web page may be processed in a manner which provides a seamless and more user-friendly viewing experience. In some examples, the embodiments herein may be incorporated within software that is deployed on a cloud platform for use with an Industrial Internet of Things (IIoT) system.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates a cloud computing system for industrial software and hardware in accordance with an example embodiment.

FIG. 2 is a flow diagram illustrating a process for rendering visual representations in accordance with an example embodiment.

FIG. 3 illustrates a computing system for rendering visual representations in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

As described herein, visual representations such as charts, tables, graphs, lines, and the like, are based on data points associated with data that may be sensed by and received from an asset such as a machine or equipment included in an Industrial Internet of Things (IoT). Examples of assets include a wind turbine, a locomotive, a jet engine, a printing press, an oil rig, and the like. A visual representation can be used to provide a user-friendly view of the data that quickly provides a user with knowledge of the underlying data that is used to generate the visual representation. Often, a user will be viewing data using different visual representations. Specific examples of visual representations include, but are not limited to, a time-series graph, a radar chart, a pie/donut chart, a polar chart, a time-series plot, an XY line scatter, a parallel coordinates, and the like. Different types of charts may be included within a chart framework that also includes the communication technology described herein.

Data to be rendered may be received from, for example, an asset or other machine or equipment. As a non-limiting example, a chart could represent a variable of pressure versus time received from an asset, or could represent a variable of temperature versus time received from the asset. In some embodiments, charts include a plurality of time-series data, each having their own representations (e.g., lines, a set of points, a set of shapes, etc.).

Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

Sensed data from or about assets is often time-series data. The time series data may include one or more variables such as speed, temperature, velocity, movement, pressure, humidity, etc., measured over time. The received/sensed time series data may include timestamps associated with each reading, measurement, etc. Accordingly, the received data may be plotted on a visual representation as data points based on the timestamps.

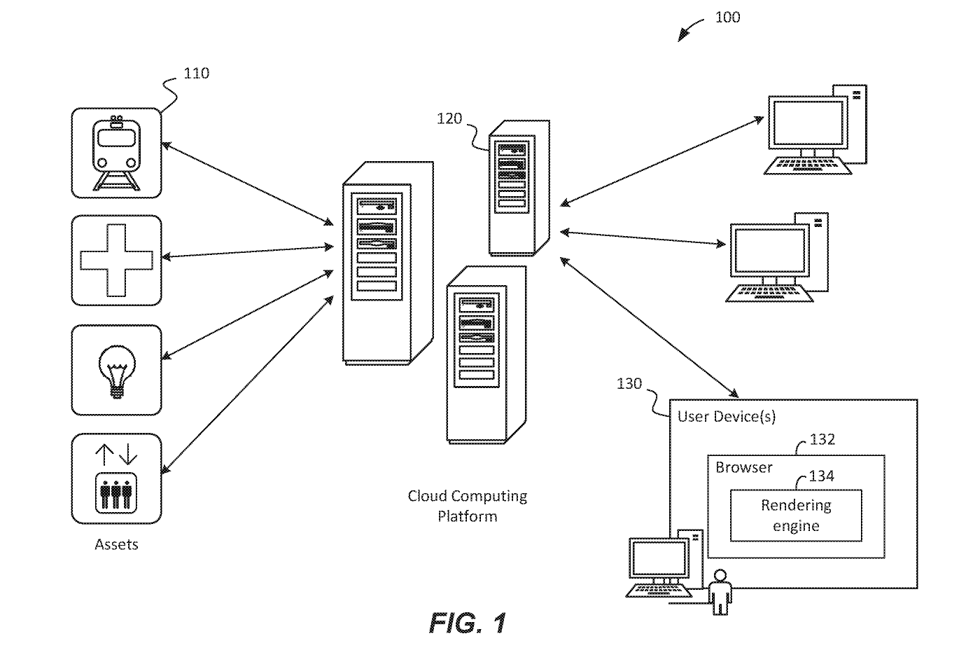

FIG. 1 illustrates a cloud computing system 100 for industrial software and hardware in accordance with an example embodiment. Referring to FIG. 1, the system 100 includes a plurality of assets 110 which may be included within an Industrial Internet of Things (IIoT) and which may transmit raw data to a source such as cloud computing platform 120 where it may be stored and processed. It should also be appreciated that the cloud platform 120 in FIG. 1 may be replaced by a non-cloud platform such as a server, an on-premises computing system, and the like.

The data transmitted by the assets 110 and received by the cloud platform 120 may include data that is being input to hardware and/or software deployed on or in association with the assets 110, raw time-series data output as a result of the operation of the assets 110, and the like. Data that is stored and processed by the cloud platform 120 may be output in some meaningful way to user devices 130.

In the example of FIG. 1, the assets 110, cloud platform 120, and user devices 130 may be connected to each other via a network such a public network (e.g., Internet), a private network, a wired network, a wireless network, etc. User devices 130 may interact with software hosted by and deployed on the cloud platform 120 in order to receive data from and control operation of the assets 110.

In some embodiments, a user device 130 includes a browser 132 having a rendering engine 134 (e.g., renderer) that renders graphics thereon. Rendering engine 134 (e.g., also known as browser engine or layout engine) is a program that renders marked up content (e.g., HTML, XML, image files, etc.) and formatting information (e.g., CSS, XSL, etc.).

It should be appreciated that the system 100 is merely an example and may include additional devices and/or one of the devices shown may be omitted. The visual representation processing software described herein may be a program or other type of software deployed on user device 130, or another device. User device 130 may include a computer, a laptop, a tablet, a mobile device, a television, an appliance, a kiosk, or any other type of device suitable for processing and/or displaying visual representations.

According to various aspects, software applications that can be used to enhance or otherwise modify the operating performance of an asset 110 may be hosted by the cloud platform 120 and may operate on the asset 110. For example, software applications may be used to optimize a performance of the assets 110 or data coming in from the asset 110. As another example, the software applications may analyze, control, manage, or otherwise interact with the asset 110 and components (software and hardware) thereof. A user device 130 may receive views of data or other information about the asset 110 as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset 110 via one or more applications hosted by the cloud platform 120.

In this example, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets 110, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110.

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

Rendering data points can be computational intensive. In a most straightforward approach, a rendering process may progressively render a default number (e.g., arbitrary, predetermined number) of points per frame. However, this typically means that a computing device with high processing power may be underused, while a computing device with low processing power may continue to experience performance issues.

A browser 132 rendering a frame typically has the following key areas in a pixels-to-screen pipeline: JavaScript, Style, Layout, Paint, and Composite. Typically, JavaScript code is used to handle work that will result in visual changes. Each of these various parts of the pipeline represents an opportunity to interfere with smooth rendering and responsiveness to user input.

Measuring execution time of the of various parts of computer-executable code is helpful for optimizing code, but it is not sufficient to analyze real-time performance and to improve overall performance to achieve smooth rendering.

To overcome this issue, examples herein may invoke a requestAnimationFrame( ) JavaScript method (herein referred to as “requestAnimationFrame method”) that notifies a browser 132 of a desire to perform an animation and requests that the browser call a specified function to update an animation before a next repaint. The requestAnimationFrame method is invoked at the beginning of each rendering cycle.

Using the requestAnimationFrame method, examples herein may measure the impact of code executed on a last frame (e.g., how increasing the number of points rendered increased the rendering time) and may take into account any other external JavaScript code running, browser internal mechanism (e.g., Style, Layout, Paint, and Composite parts of a rendering cycle), and/or any intensive processing currently happening on a computing device 130.

By way of example, if other software is running on the computing device 130 and consuming large amounts of CPU resources, then the browser will decrease the number of frames rendered, which will in turn decrease the amount of data rendered. As a result, the visual processing of the representations displayed via web page may be processed smoothly without lag, creating a user-friendly viewing experience. Furthermore, a smooth animation may be achieved on any computer and on any browser, independent of hardware capabilities.

Rendering engine 134 uses the requestAnimationFrame method to gather information regarding a rendering speed for each type of rendering (e.g., a line, any kind of shaped marker, a component highlighting some specific points, etc.) based on current machine hardware, web browser, and CPU availability. Typically, different rendering types render at different speeds. Rendering engine 134 uses this information to run an appropriate amount of code before waiting for the next rendering cycle to continue rendering, repeating until all targets have been rendered.

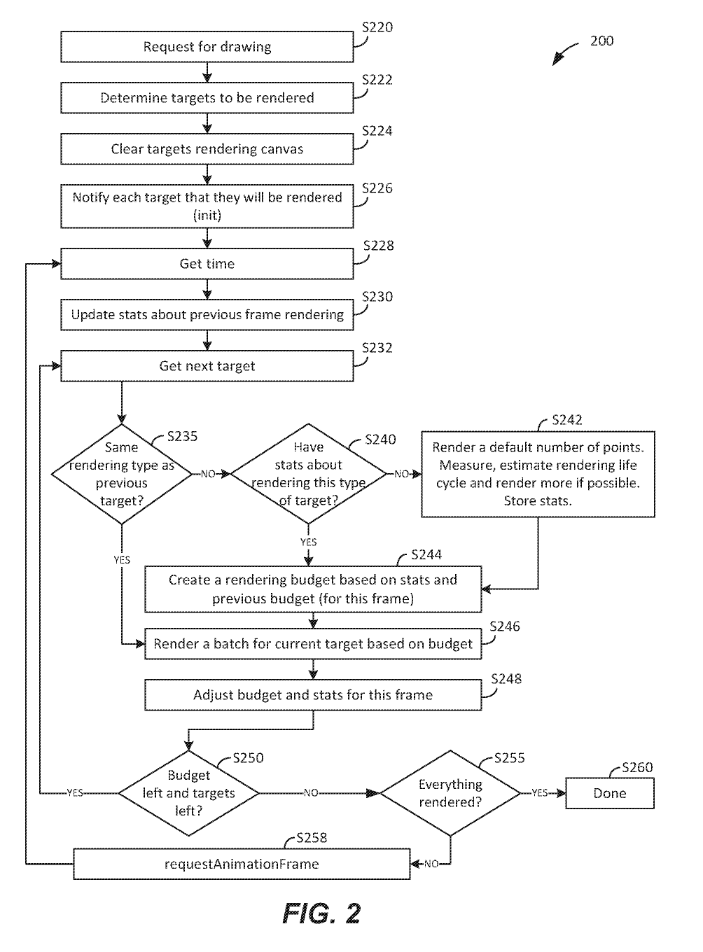

FIG. 2 is a flow diagram illustrating a process 200 for rendering visual representations of data in accordance with an example embodiment. For example, process 200 may be performed by the software and/or the system described herein.

Typically, devices refresh their screens 60 times per second. Thus, in order for a browser to match the device's refresh rate and perform acceptably, the browser should complete one new frame for each screen refresh (e.g., 60 frames per second (fps)). Each frame has a budget of just over 16 milliseconds (1 second/60=16.66 ms). Other time periods for the frame rate are possible. When the budget is not met (e.g., application does not keep up with the refresh rate), the frame rate drops, and content stutters, lags, and/or halts, resulting in poor user experience.

Initially, at S220, a processing component of a browser (e.g., rendering engine 134) may receive a processing request of a visual representation to be displayed on a web page. For example, the processing request may include a request (e.g., by a user at a user device 130) to draw a visual representation on a web page on a web browser (e.g., browser 132).

In some embodiments, the rendering engine of the browser uses HTML Canvas element(s) to facilitate dynamic, scriptable rendering of shapes, images, and/or other graphical elements. In some embodiments, rendering engine 134 may also render using Web Graphics Library (WebGL) or Scalable Vector Graphics (SVG). Rendering engine 134 can provide a variety of dynamic two-dimensional (2D) and/or three-dimensional (3D) renderings for viewing (and interaction) by a user via a user interface.

In turn, at S222, the processing component determines targets to be rendered from a target list based on the request. Advantageously, a requestAnimationFrame application programming interface (API) provides web developers with a means to create smooth animations. In some embodiments, a requestAnimationFrame function, handled by the browser, is used to render frame-by-frame.

Targets may register (e.g., add) themselves to a target list of objects to be rendered and unregister (e.g., remove) themselves from a target list of objects to be rendered, for example, by firing an event. The rendering engine catches the event and registers/unregisters the targets accordingly.

Each target that is drawn on a canvas that is linked to it. Multiple targets may be drawn on the same canvas. Before rendering the targets, the canvas linked to the target is cleared, at S224, for each target that is to be rendered.

At S226, at the start of rendering, a function (e.g., initialize rendering) may be invoked on each rendering target to carry out initialization work (e.g., to ensure that configurations are up-to-date, etc.).

A start time (e.g., timestamp) is retrieved at S228. When the process loops from steps S228 through S258, an end time (e.g., timestamp) is retrieved, back at S228. Each iteration of the loop from steps S228 through S258 represents one frame of a rendering cycle. The timestamp may be a UNIX timestamp that represents the start/end time of a rendering cycle. In some embodiments, the timestamp may be returned using a Performance.now( ) JavaScript method, measured in milliseconds and accurate to microsecond precision. The returned value represents the time elapsed since a time origin.

Statistics about each frame rendering is updated at each rendering cycle of a frame. The statistics include information regarding different rendering types (e.g., lines, shapes, etc.) and information regarding different components rendered, for example, on a chart (e.g., data itself, cursors on top of the data), and the like. If statistics about a previous frame rendering are available, those statistics are updated at S230. If not, then that step is skipped.

By way of example, statistics for a chart may include “chartData”, “filteredChartData”, “highlightData”, and “markers”. Each of these features keep track of statistics for their respective targets based on rendering type (e.g., line or scatter). For purposes of illustration, consider the following example of statistics that are tracked:
{chartData: { . . . }, filteredChartData: { . . . }, highlightData: { . . . }, markers: { . . . }}chartData:
   line: Array(2)
      0: {points: 13000, duration: 27.889784946237373}
      1: {points: 7161, duration: 22.66314164415317}
   scatter: Array(5)
      0: {points: 1358, duration: 20.30499999999938}
      1: {points: 1370, duration: 21.225000000000364}
      2: {points: 1312, duration: 19.154999999999745}
      3: {points: 1327, duration: 20.1299999999992}
      4: {points: 1343, duration: 20.780000000000655}
filteredChartData: {line: Array(0), scatter: Array(0)}
highlightData: {line: Array(0), scatter: Array(0)}
markers: {line: Array(0), scatter: Array(0)}

By way of example, a target list may include a number of registered targets. For purposes of illustration, consider the following example of a target list where four targets are registered, all under “chartData”, three of which are of a “scatter” type and one of which is of a “line” type:
{chartData: Array(4), filteredChartData: Array(0), highlightData: Array(4), markers: Array(0)}
   chartData: Array(4)
      0: {target: px-vis-scatter-canvas, type: “scatter”}
      1: {target: px-vis-line-canvas # lineCanvas, type: “line”}
      2: {target: px-vis-scatter-canvas, type: “scatter”}
3: {target: px-vis-scatter-canvas, type: “scatter”}
   filteredChartData: [ ]
   highlightData: (4) [{ . . . }, { . . . }, { . . . }, { . . . }]
   markers: [ ]

From this information, the processing component can infer how many points it can draw for a type of rendering.

At S232, a next target (hereinafter referred to as “current target”) is retrieved, and in the case of a first frame, a first target is retrieved. In turn, the processing component determines the rendering type of the current target (e.g., a line, a shaped marker, etc.).

At S235, in a case where the rendering type of the current target is of the same rendering type as a previous target, a batch of graphical data are rendered for the current target based on a budget (e.g., a number of points that may be rendered in one frame). For example, a batch of points may be drawn on a canvas based on data type (e.g., a line with fifty points). Initially, the budget may be set at an arbitrary number (e.g., a percentage) that is adjusted as more information (e.g., rendering statistics) becomes available.

At S235, in a case where the rendering type of the current target is not of the same rendering type as the previous target, it is determined, at S240, whether statistics are available about rendering that type of target (of the current target).

Where statistics about rendering a specific type of target are not available, at S240, this indicates that the processing component has not yet processed a first frame for that specific rendering type. In this case, for a first frame, a default (e.g., arbitrary, hard-coded) number of points are rendered for each rendering type (e.g., lines, shapes, etc.) at S242. Rendering engine 134 draws this default number of points on the canvas and estimates the execution duration of the rendering life cycle to generate a first set of statistics for the first frame. In some embodiments, the statistics may be stored “in-memory” (e.g., Random Access Memory (RAM)) on a user device.

At S240, in a case where statistics are available about rendering the specific type of target, a rendering budget is created for the current frame, at S244, based on the available statistics and a previous budget. A batch of graphical data are rendered for the current target at S246 based on the budget created at S244.

The budget and statistics for the current frame are updated (e.g., adjusted) at S248 based on the amount of data that was rendered at S246. Next, at S250, it is determined whether there are any budget and any targets left. If there are still some budget and some targets remaining, flow returns to S232 to retrieve a next sequential target for rendering in the current frame and proceeds onward from that as described above. If not, it is determined, at S255, whether there are any targets left to be rendered.

In this way, the rendering engine takes into account a case in which all the points for the current target have been rendered in the current frame, but based on the statistics, more points could have been rendered. Knowing this, the rendering engine selects the next sequential target and uses what is left of the budget for rendering in the current frame before moving on to the next frame. By way of example, if the current target is a line, the rendering engine will know (e.g., from the statistics) that it can render 1,000 line points per frame, but the current target only has 400 points in total, which have been rendered, then the rendering engine will update the budget (e.g., 100−40=60, in percentage) and render the next sequential target in the current frame with a budget of 60 before moving on to the next frame.

If it is determined that everything has been rendered, the rendering cycle is complete at S260. If it is determined that everything has not yet been rendered, the requestAnimationFrame method is invoked, as it will be at the beginning of each rendering cycle, and flow returns to S228 to retrieve an end time for the current frame. In some embodiments, the browser will aim to synchronize the invocation of the requestAnimationFrame method with the display's refresh rate (e.g., 60 frames per second).

Based on the timestamp difference between the start time and the end time (e.g., the timestamp difference between a current frame and the immediately previous frame), the time consumed in rendering the current frame (e.g., JavaScript, Style, Layout, Paint, and Composite) may be calculated at S228, and the statistics about the previous frame rendering updated at S230. Flow proceeds onward from S230 as described above for rendering a next sequential frame.

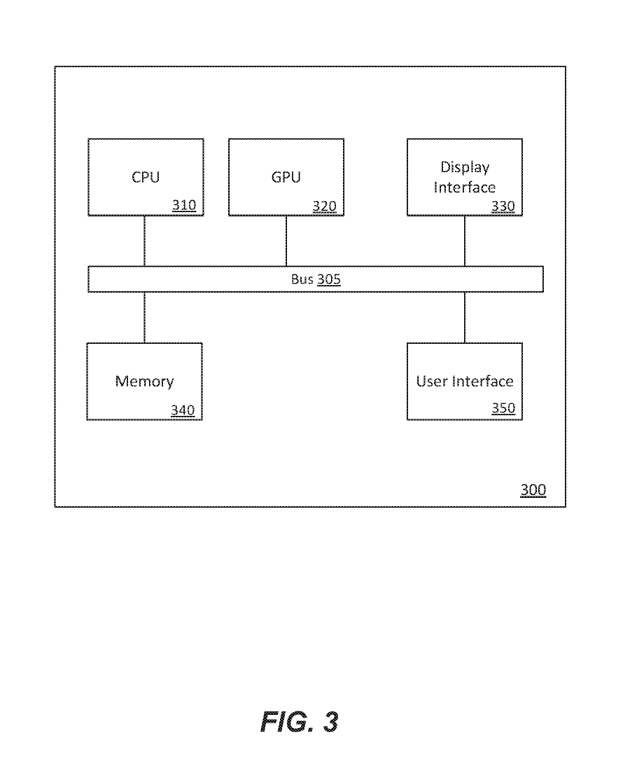

FIG. 3 illustrates a computing system 300 for rendering visual representations of data in accordance with an example embodiment. The computing system 300 may perform the method of FIG. 2. Generally, computer system 300 includes one or more processors such as central processing unit (CPU) 310, coupled to a system memory 340. Computing system 300 also includes display interface 330 and user interface 350 coupled to devices such as an input/output unit and a display (not shown). In some embodiments, at least one processor may be a graphics processing unit (GPU) 320 or other graphics hardware. CPU 310, GPU 320, display interface 330, memory 340, and user interface 350 may communicate with each other via bus 305.

System 300 can be implemented as, for example, a desktop computer system or server computer system, having a CPU 310 coupled to a dedicated graphics rendering GPU 320. In some embodiments, all the hardware elements shown in FIG. 3 may be implemented as a system-on-a-chip (SoC), or the like.

Although not shown in FIG. 3, the computing system 300 may include other components such as a network interface, a display, an input/output unit, a receiver/transmitter, and the like. Processor 310 may include one or more processing devices each including one or more processing cores. In some examples, the processor is a multicore processor or a plurality of multicore processors. Also, the processor may be fixed or it may be reconfigurable.

Software applications executing on CPU 310 may include one or more rendering instructions that instructs the CPU 310 to cause the rendering of graphics data to a display. In some embodiments, a rendering engine running on CPU 310 issues one or more graphics rendering commands to GPU 320 to perform some or all of the rendering of graphics data.

System memory 335 may store program instructions for execution by processors 310, 320. System memory 335 is not limited to any particular storage device and may include any known memory device such as RAM, ROM, hard disk, and the like.

As will be appreciated based on the foregoing specification, the above-described examples of the disclosure may be implemented using computer programming or engineering techniques including computer software, firmware, hardware or any combination or subset thereof Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving a processing request to render a visual representation on a browser;
identifying a current target of a plurality of targets for rendering;
rendering the current target using a browser processing component, and based on an ordered rendering;
obtaining rendering information about the rendering of the current target, the rendering information including an amount of points being output and a time interval for rendering the amount of points; and
determining an amount of future rendering points to output for the visual representation during a future time interval based on the rendering information obtained for the current target.

2. The computer-implemented method of claim 1, wherein the plurality of targets include targets of different rendering types, and the method further comprises storing rendering information for each target based on a rendering type.

3. The computer-implemented method of claim 2, further comprising:
determining a rendering type of the current target and a rendering type of a previous target that immediately precedes the current target;
determining whether the rendering type of the current target is the same as the rendering type of the previous target; and
rendering a batch of points for the current target based on a rendering budget defining an amount of points to be rendered in a frame during a predetermined period of time for the rendering type of the previous target, in a case where the rendering types are the same.

4. The computer-implemented method of claim 2, further comprising:
determining whether rendering information about a rendering type of the current target have been obtained; and
creating a rendering budget based on the rendering information about the rendering type of the current target and a previous rendering budget, in a case where the rendering information about the rendering type of the current target have been obtained.

5. The computer-implemented method of claim 1, wherein the determining an amount of future rendering points further comprises:
increasing or decreasing a number of points to be rendered based on the obtained rendering information about the rendering of the current target.

6. The computer-implemented method of claim 1, wherein the obtaining the time interval further comprises:
determining a first time at which a browser processing component began rendering the current target;
determining a second time at which the browser processing component began rendering a previous target that immediately precedes the current target; and
storing the time interval corresponding to the amount of time between the first time and the second time.

7. The computer-implemented method of claim 1, further comprising invoking an animation function, handled by the browser, at the beginning of each rendering cycle for rendering each frame, wherein the animation function notifies the browser of an animation and requests the browser to call a specified function to update an animation before a next repaint.

8. A computing system comprising:
a memory storing instructions; and
a processor configured to execute the instructions, wherein the executed instructions cause the processor to:
receive a processing request to render a visual representation on a browser;
identify a current target of a plurality of targets for rendering;
render the current target using a browser processing component, and based on an ordered rendering;
obtain rendering information about the rendering of the current target, the rendering information including an amount of points being output and a time interval for rendering the amount of points; and
determine an amount of future rendering points to output for the visual representation during a future time interval based on the rendering information obtained for the current target.

9. The computing system of claim 8, wherein the plurality of targets includes targets of different rendering types, and the processor is further configured to store rendering information for each target based on a rendering type.

10. The computing system of claim 9, wherein the processor is further configured to:
determine a rendering type of the current target and a rendering type of a previous target that immediately precedes the current target;
determine whether the rendering type of the current target is the same as the rendering type of the previous target; and
render a batch of points for the current target based on a rendering budget defining an amount of points to be rendered in a frame during a predetermined period of time for the rendering type of the previous target, in a case where the rendering types are the same.

11. The computing system of claim 9, wherein the processor is further configured to:
determine whether rendering information about a rendering type of the current target have been obtained; and
create a rendering budget based on the rendering information about the rendering type of the current target and a previous rendering budget, in a case where the rendering information about the rendering type of the current target have been obtained.

12. The computing system of claim 8, wherein the determining an amount of future rendering points further comprises the processor further configured to:
increase or decrease a number of points to be rendered based on the obtained rendering information about the rendering of the current target.

13. The computing system of claim 8, wherein the obtaining the time interval further comprises the processor further configured to:
determine a first time at which a browser processing component began rendering the current target;
determine a second time at which the browser processing component began rendering a previous target that immediately precedes the current target; and
store the time interval corresponding to the amount of time between the first time and the second time.

14. The computing system of claim 8, wherein the processor is further configured to invoke an animation function, handled by the browser, at the beginning of each rendering cycle for rendering each frame, wherein the animation function notifies the browser of an animation and requests the browser to call a specified function to update an animation before a next repaint.

15. A non-transitory computer readable medium having stored therein instructions that when executed cause a computer to perform a method comprising:
receiving a processing request to render a visual representation on a browser;
identifying a current target of a plurality of targets for rendering;
rendering the current target using a browser processing component, and based on an ordered rendering;
obtaining rendering information about the rendering of the current target, the rendering information including an amount of points being output and a time interval for rendering the amount of points; and
determining an amount of future rendering points to output for the visual representation during a future time interval based on the rendering information obtained for the current target.

16. The non-transitory computer readable medium of claim 15, wherein the plurality of targets includes targets of different rendering types, and the method further comprises storing rendering information for each target based on a rendering type.

17. The non-transitory computer readable medium of claim 16, the method further comprising:
determining a rendering type of the current target and a rendering type of a previous target that immediately precedes the current target;
determining whether the rendering type of the current target is the same as the rendering type of the previous target; and
rendering a batch of points for the current target based on a rendering budget defining an amount of points to be rendered in a frame during a predetermined period of time for the rendering type of the previous target, in a case where the rendering types are the same.

18. The non-transitory computer readable medium of claim 16, the method further comprising:
determining whether rendering information about a rendering type of the current target have been obtained; and
creating a rendering budget based on the rendering information about the rendering type of the current target and a previous rendering budget, in a case where the rendering information about the rendering type of the current target have been obtained.

19. The non-transitory computer readable medium of claim 15, wherein the determining an amount of future rendering points further comprises:
increasing or decreasing a number of points to be rendered based on the obtained rendering information about the rendering of the current target.

20. The non-transitory computer readable medium of claim 15, the method further comprising invoking an animation function, handled by the browser, at the beginning of each rendering cycle for rendering each frame, wherein the animation function notifies the browser of an animation and requests the browser to call a specified function to update an animation before a next repaint.
